(19) United States
(12) Patent Application Publication
(10) Pub. No.: US 2026/0084070 A1
(43) Pub. Date: Mar. 26, 2026

(54) ELECTRONIC DEVICE AND CONTACTLESS CHARGING SYSTEM

(71) Applicant: CASIO COMPUTER CO., LTD., Tokyo (JP)

(72) Inventors: Kohei MIURA, Tokyo (JP); Yasuhiro TSUYUKI, Tokyo (JP); Tomio HIGO, Tokyo (JP)

(73) Assignee: CASIO COMPUTER CO., LTD., Tokyo (JP)

(21) Appl. No.: 19/338,607

(22) Filed: Sep. 24, 2025

(30) Foreign Application Priority Data
Sep. 24, 2024 (JP) 2024-165723

(51) Int. Cl. A63H 29/22; A63H 3/44; A63H 3/52; A63H 13/00; H01M 50/264; H02J 50/00; H02J 50/10

(52) U.S. Cl. CPC A63H 29/22; A63H 3/52; A63H 13/005; H01M 50/264; H02J 50/005; H02J 50/10; A63H 3/44

(57) ABSTRACT

An electronic device includes: a body that accommodates a first consumable part and at least a part of second consumable parts, wherein the body includes a first casing to which the first consumable part and the second consumable parts are attached, and a second casing that engages with the first casing in an orientation that the second casing faces the first casing in a first direction, the first consumable part and the second consumable parts are arranged to at least partially overlap with each other in a direction along the first direction, and the first consumable part and the second consumable parts that are arranged to overlap with each other in the direction along the first direction are configured to be removable independently of each other.

### CROSS-REFERENCE TO RELATED APPLICATIONS

This application claims the benefit of Japanese Patent Application No. 2024-165723, filed on Sep. 24, 2024, the entire disclosure of which is incorporated by reference herein.

### FIELD OF THE INVENTION

The present disclosure relates to an electronic device and a contactless charging system.

### BACKGROUND OF THE INVENTION

Unexamined Japanese Patent Application Publication No. 2022-149408 (Patent Literature 1) discloses a pet robot that is capable of operating the head by communicating with a user. FIG. 21 of the present application is an exploded perspective view of the main body portion 207 which is a housing.

### SUMMARY OF THE INVENTION

An electronic device according to an aspect of the present disclosure includes: a body that accommodates a first consumable part and at least a part of a second consumable part, wherein the body includes a first casing to which the first consumable part and the second consumable part are attached, and a second casing that engages with the first casing in an orientation that the second casing faces the first casing in a first direction, the first consumable part and the second consumable part are arranged to at least partially overlap with each other in a direction along the first direction, and the first consumable part and the second consumable part that are arranged to overlap with each other in the direction along the first direction are configured to be removable independently of each other.

### BRIEF DESCRIPTION OF DRAWINGS

A more complete understanding of this application can be obtained when the following detailed description is considered in conjunction with the following drawings, in which:

FIG. 1 is a diagram illustrating an appearance of a robot according to an embodiment;

FIG. 2 is a schematic cross-sectional view of the robot according to the embodiment as viewed from the side;

FIG. 3 is a perspective view of a housing according to the embodiment;

FIG. 4 is a cross-sectional view of the housing taken along line IV-IV of FIG. 3;

FIG. 5 is an exploded perspective view of a first casing of a torso of the housing vertically inverted from that illustrated in FIG. 3;

FIG. 6 is a perspective view of the first casing illustrated in FIG. 5;

FIG. 7 is a perspective view of an action unit illustrated in FIG. 5;

FIG. 8A is a perspective view of an action unit fixture illustrated in FIG. 5;

FIG. 8B is another perspective view of the action unit fixture illustrated in FIG. 5;

FIG. 9 is a plan view of the housing from which a second casing, a secondary battery, and a battery retainer are removed, vertically inverted from that illustrated in FIG. 3;

FIG. 10A is a perspective view of a substrate base illustrated in FIG. 5;

FIG. 10B is another perspective view of the substrate base illustrated in FIG. 5;

FIG. 11 is a perspective view of the second casing and components attached to the second casing vertically inverted from those illustrated in FIG. 5;

FIG. 12 is a perspective view of the second casing and the components attached to the second casing illustrated in FIG. 11 in a state in which the components such as a coil retainer are detached from peripheral edges of an opening of the second casing;

FIG. 13 is a perspective view of the second casing according to the embodiment;

FIG. 14 is an exploded perspective view of the components such as the coil retainer of the second casing illustrated in FIG. 11 that are detached from the second casing;

FIG. 15A is a perspective view of the coil retainer according to the embodiment;

FIG. 15B is another perspective view of the coil retainer according to the embodiment;

FIG. 16 is a perspective view of a power reception coil and a power reception substrate vertically inverted from those illustrated in FIG. 14;

FIG. 17 is a cross-sectional view of the housing taken along line XVII-XVII of FIG. 3;

FIG. 18 is a plan view of the housing from which the second casing is removed, vertically inverted from that illustrated in FIG. 3;

FIG. 19 is a perspective view of a contactless charging unit according to the embodiment;

FIG. 20 is a cross-sectional view of the contactless charging unit taken along line XX-XX of FIG. 19; and

FIG. 21 is an exploded perspective view of a housing according to Patent Literature 1.

### DETAILED DESCRIPTION OF THE INVENTION

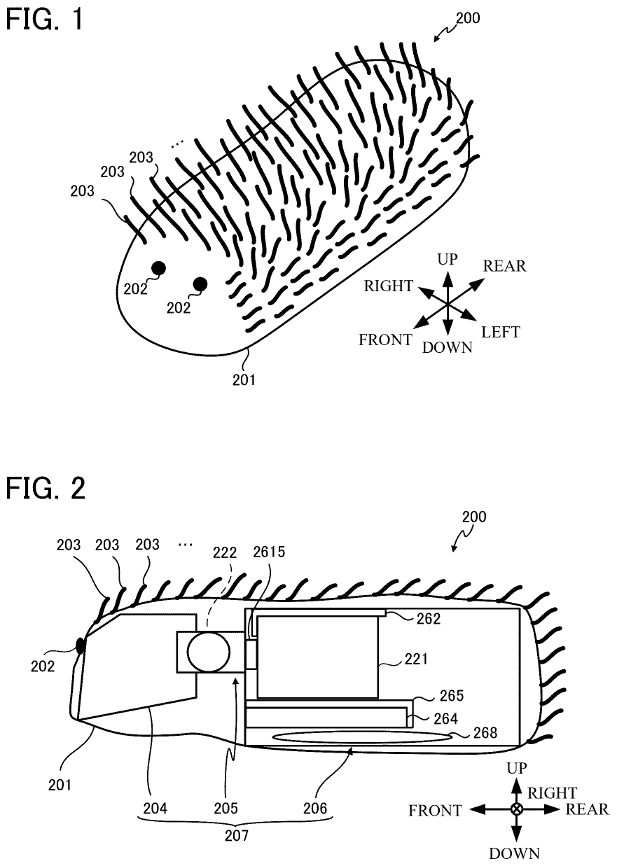

Hereafter, embodiments of the present disclosure are described with reference to the drawings. In these drawings, components that are the same or equivalent are assigned the same reference sign. A robot 200 according to an embodiment is a pet robot that resembles a small animal. The robot 200 is powered by a contactlessly rechargeable battery to swing its head, that is, the part corresponding to the head. As illustrated in FIG. 1, for example, the robot 200 includes an exterior 201 having decorative parts 202 resembling eyes, and fur 203. As illustrated in FIG. 2, the robot 200 includes a housing 207. The housing 207 is covered with the exterior 201 and accommodated inside the exterior 201. The housing 207 is an electronic device including a head 204, a coupler 205, and a torso 206 or a casing. The coupler 205 couples the head 204 that is a movable section to the torso 206 that is a body of the robot 200.

As illustrated in FIG. 21, a pet robot disclosed in Patent Literature 1 includes a housing 500 including includes a secondary battery 507 and an action unit 506 that includes a head 501, motors 502 and 503 to operate the head 501, a neck 504 to accommodate the motor 502, and a substrate 505 for controlling the motors are consumable parts. These components need to be replaced after a certain period of use. However, in the inventions of Patent Literature 1, for example, replacing the secondary battery 507 requires removing an upper casing 508 and then detaching the action unit 506 from a lower casing 509, which entails disassembling most of the components of the housing 500. As a result, many screws and other fasteners must be removed, making the replacement process cumbersome. Furthermore, since the action unit 506 includes many components, a large number of screws and other fasteners are used to secure it to the upper casing 508 and the lower casing 509, further complicating the process for replacement of the action unit 506.

The present disclosure is made with the view of the above situation, and an objective of the present disclosure is to provide an electronic device and a contactless charging system in which maintenance of consumable parts can be performed easily.

The following assumes the robot 200 normally placed on a horizontal floor, and defines that the part corresponding to the face of the robot 200, that is, the part of the head 204 opposite to the torso 206 is oriented frontward, and the part corresponding to the tail of the robot 200, that is, the part of the torso 206 opposite to the head 204 is oriented rearward. The description also defines that the part of the robot 200 in contact with the horizontal floor on which the robot 200 is placed is oriented downward, and the opposite part is oriented upward. The description further defines, as the right-left direction, the direction orthogonal to both the front-rear direction and the up-down direction of the robot 200.

The exterior 201 is an example of an exterior member. The exterior 201 is elongated in the front-rear direction, and has a pouched shape capable of accommodating the housing 207 therein. The exterior 201 has a barrel shape from the head 204 to the torso 206, and integrally covers the torso 206 and the head 204. Due to the exterior 201 having such a shape, the robot 200 is formed in a shape as if lying on its belly. An outer material of the exterior 201 is made of an artificial pile fabric that resembles the fur 203 of a small animal to imitate the feel of a small animal. The lining of the exterior 201 is made of a flexible material, such as leather, resin, or rubber. This flexible material allows the exterior 201 to follow the movement of the housing 207. Specifically, the exterior 201 follows the turning movement of the head 204 that is a movable section relative to the torso 206.

As illustrated in FIG. 2, the torso 206 extends in the front-rear direction. The torso 206 is in contact via the exterior 201 with a placement surface, such as floor or table, on which the robot 200 is placed. The torso 206 includes a twist motor 221 at the front end. The front end of the torso 206 is coupled to the head 204 via the coupler 205. The coupler 205 includes a vertical motor 222. The head 204 is coupled to the torso 206 such that the head 204 is rotatable about the right-left direction and the front-rear direction of the robot 200 as axes.

The coupler 205 couples the head 204 to the body 206 such that the head 204 is rotatable about (a fastener 291 that is screwed to) a motor rotational axis 2615 illustrated in FIGS. 2 and 4. The motor rotational axis 2615 is a first rotational axis extending through the coupler 205 in the front-rear direction of the torso 206. The twist motor 221 is a servo motor to cause the head 204 to normally turn in the clockwise (rightward turning) direction or reversely turn in the counterclockwise (leftward turning) direction, about the first rotational axis relative to the torso 206. The coupler 205 also couples the head 204 to the torso 206 such that the head 204 is rotatable about a second rotational axis extending through the coupler 205 in the right-left direction of the torso 206. The vertical motor 222 is a servo motor to cause the head 204 to normally turn in the upward direction or reversely turn in the downward direction about the second rotational axis. The twist motor 221 and the vertical motor 222 are components of a motor section that operates the head 204. The twist motor 221 is an example of a first motor, and the vertical motor 222 is an example of a second motor.

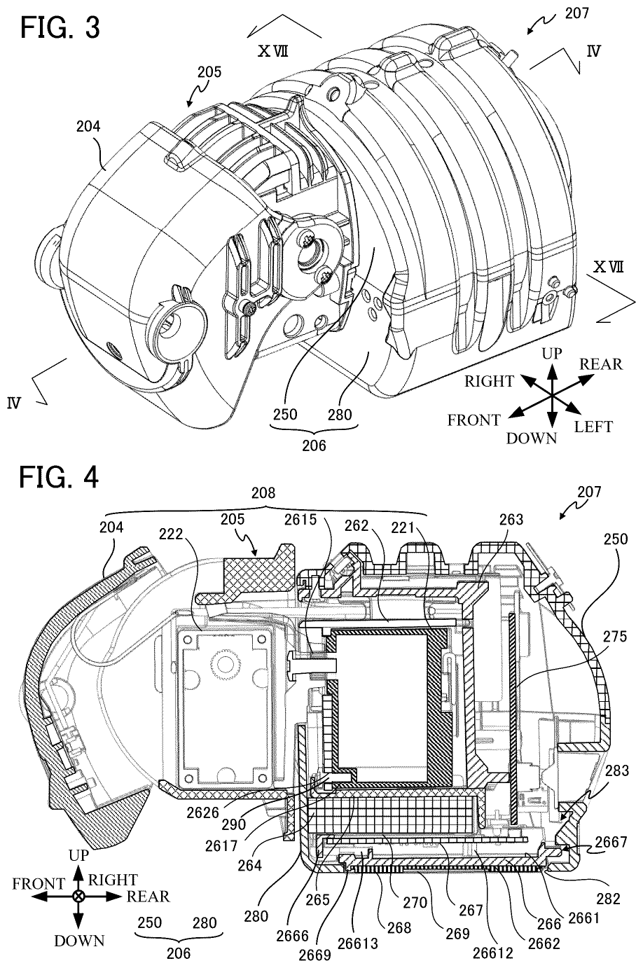

As illustrated in FIGS. 3 and 4, the torso 206 is a hollow cylindrical casing made of an acrylonitrile butadiene styrene (ABS) resin, for example. The torso 206 includes a first casing 250 that constitutes the dorsal part of the torso 206 of the robot 200, and a second casing 280 that constitutes the abdominal part of the torso 206 of the robot 200. The torso 206 accommodates the twist motor 221, a secondary battery 264, a battery retainer 265, a coil retainer 266, and a power reception coil 268, for example.

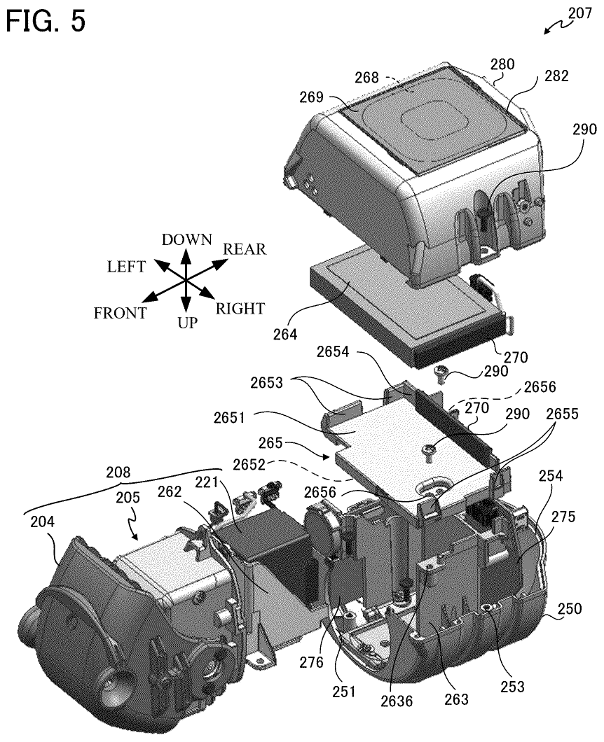

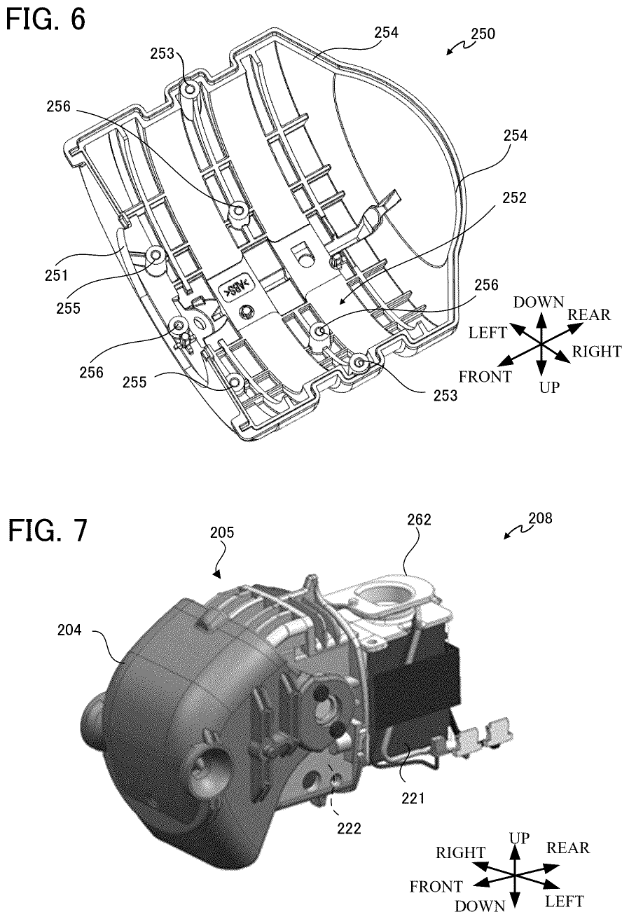

As illustrated in FIGS. 4, 5, and 6, the first casing 250 accommodates the twist motor 221 that provides power the head 204, an action unit fixture 262 that stabilizes the twist motor 221 and the coupler 205 to the torso 206, a substrate base 263 provided with substrates, such as a primary substrate 275, the secondary battery 264 that feeds electric power to the robot 200, the battery retainer 265 that retains the secondary battery 264, the primary substrate 275 that controls the robot 200, and a programmable system-on-chip (PSoC) substrate 276. The first casing 250 forms the upper half of the outer shell of the torso 206. As illustrated in FIGS. 5 and 6, the first casing 250 has an action unit fixture through-hole 251 on the front to allow the motor rotational axis 2615 of the twist motor 221 and the vertical motor 222 to extend into the coupler 205. The action unit fixture through-hole 251 has a diameter that is considerably larger than the motor rotational axis 2615, so that the action unit fixture 262 accommodating the twist motor 221 is removable while sliding it in the forward direction. The first casing 250 has screw holes 253 and engaged edges 254 that serve to integrate the first casing 250 and the second casing 280. Screw holes 255 serve to fasten the action unit fixture 262 to an interior 252 of the first casing 250. Screw holes 256 serve to fasten the substrate base 263 to the interior 252 of the first casing 250.

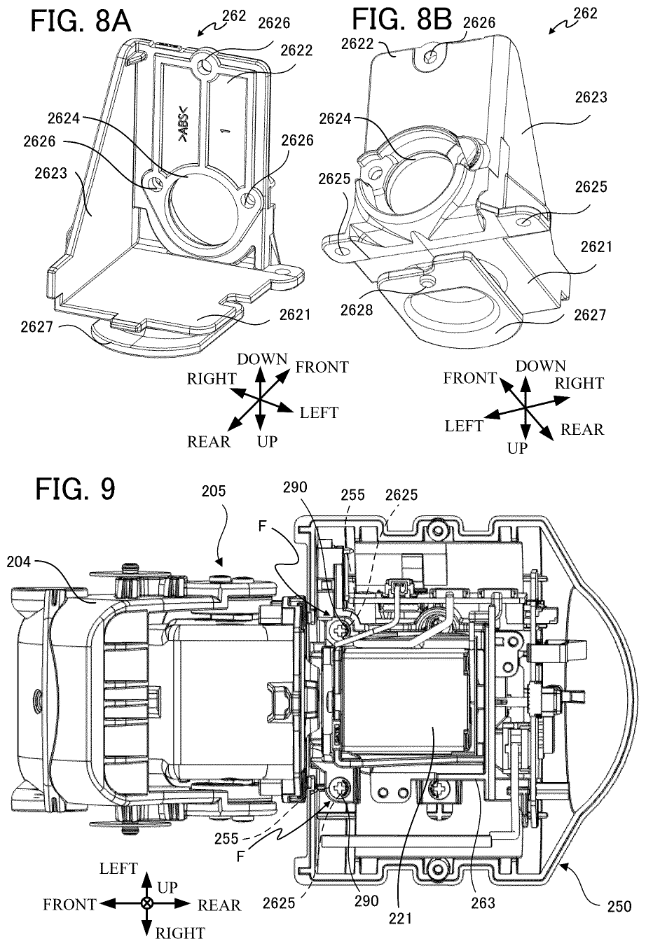

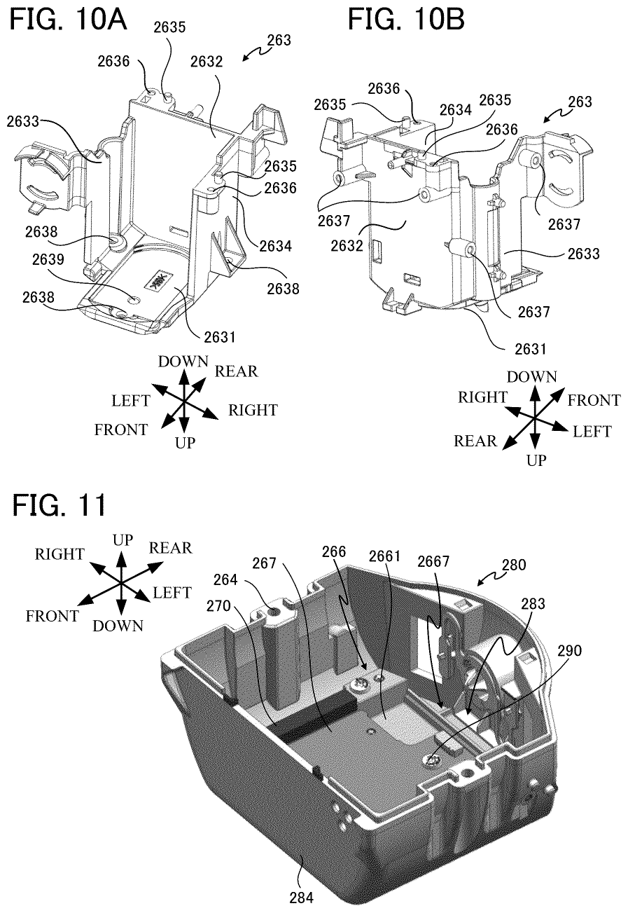

The twist motor 221 functions as an action unit 208, along with the head 204, the coupler 205, the vertical motor 222 inside the coupler 205, and the action unit fixture 262, which is described below. The action unit 208 illustrated in FIG. 7 enables the movement of the robot 200. The action unit 208 is a consumable part or a second consumable part to be replaced with a new action unit 208 after use for a certain period. As illustrated in FIG. 4, the head 204 is operated by the motor rotational axis 2615 of the twist motor 221 protruding from the body of the twist motor 221, and the rotation being transmitted to a gear inside the coupler 205. The coupler 205 and the twist motor 221 are rotatably connected via the motor rotational axis 2615. The twist motor 221 has three screw holes 2617 provided on a front panel of the twist motor 221. The three screw holes 2617 are used to fasten the twist motor 221 to the action unit fixture 262 that is also referred to as a motor fixture. Electric power from the secondary battery 264 is supplied via a connector, which is not illustrated, located behind the twist motor 221. The action unit fixture 262 illustrated in FIGS. 8A and 8B stabilizes the action unit 208 with fasteners 290 such as screws at an upper front position of the first casing 250 of the torso 206. With the upper surface of the twist motor 221 in contact with the lower surface of a base 2621, the front panel of the twist motor 221 in contact with a fixture 2622 while fitting a circular protrusion of the twist motor 221 into a motor protrusion insertion hole 2624, and the right surface of the twist motor 221 in contact with a side wall 2623, the fasteners 290 such as screws are fastened to three holes 2626 and three screw holes 2617, thereby the action unit 208, more specifically, the twist motor 221 of the action unit 208, is stabilized by the action unit fixture 262 (see FIG. 4). Furthermore, the action unit fixture 262 is positioned with an abutment 2627 formed at the top of the base 2621 in contact with a base 2631, which is described later, of the substrate base 263, and a fixing projection 2628 being inserted into a fixing hole 2639, which is described later, of the substrate base 263. The action unit fixture 262 is fastened to the first casing 250 and the substrate base 263 with fasteners 290 such as screws being fastened to two screw holes 2625 and two screw holes 255. As illustrated in FIG. 9, the two screw holes 2625 and the two screw holes 255 (and the fasteners 290 in some cases) are action unit attachment sites F that are also referred to as motor fixture attachment sites or second attachment sites. The action unit attachment site F is provided at a tool manipulatable position where tools such as a screwdriver can be manipulated to attach and detach the fasteners 290 in order to remove the action unit 208 (specifically, the twist motor 221) from the first casing 250. The action unit attachment site F is not covered by other components, excluding the secondary battery 264 and the battery retainer 265, arranged within the first housing 250, and remains exposed in a state that allows manipulation of tools such as a screwdriver to attach and detach the fasteners 290 within the first casing 250. A tool manipulatable position refers to a position at which a sufficient space that allows a screw to be moved into a screw hole in the front-rear, and right-left directions is provided, and a sufficient vertical clearance that allows attachment and tightening of the screw using a tool such as a suspended electric screwdriver, is provided. As illustrated in FIGS. 4, 5, 10A, and 10B, the primary substrate 275 is attached to a rear wall 2632 of the substrate base 263 using two substrate attachment bases 2637, and the PSoC substrate 276 is attached to a left wall 2633 of the substrate base 263 using two substrate attachment bases 2637. The substrate base 263 is attached to the first casing 250 using three screw holes 2638 provided in the base 2631. To the lower ends of the rear wall 2632 and a right wall 2634 of the substrate base 263, battery retainer fixing projections 2635 and screw holes 2636 are provided. The battery retainer fixing projections 2635 and the screw holes 2636 are provided at a height that allows the action unit fixture 262 accommodating the twist motor 221 to be disposed in a position surrounded by the rear wall 2632, the left wall 2633, and the right wall 2634 of the substrate base 263. With this configuration of the substrate base 263, components such as the twist motor 221, the secondary battery 264, the primary substrate 275, and the PSoC substrate 276 can be compactly arranged, while also ensuring the structural strength of the substrate base 263.

The secondary battery 264 that feeds electric power to the robot 200 can be recharged contactlessly. The secondary battery 264 is also a consumable part or a first consumable part to be replaced with a new secondary battery 264 after use for a certain period. As illustrated in FIG. 5, the secondary battery 264 is provided with impact buffers 270 to protect the sites of protection circuit boards inside the battery. The battery retainer 265 has a lower main surface 2651 and peripheral walls 2653, 2654, and 2655 that support the secondary battery 264, and thus protects the secondary battery 264 from vibrations and shocks in cooperation with the impact buffers 270, for example. The battery retainer 265 has an upper main surface 2652 provided with screw holes 2656, and the screw holes 2656 are fixed to screw holes 2636 at the lower end of the substrate base 263 with two fasteners 290 such as screws. The screw holes 2656 and the screw holes 2636 are first attachment sites. With the secondary battery 264 being removed from the battery retainer 265, the first attachment site is provided at a tool manipulatable position at which a tool is manipulatable for removing the battery retainer 265 from the substrate base 263. The rear peripheral wall 2654 extending downward from the lower main surface 2651, among the peripheral walls 2653, 2654, and 2655, is provided with an impact buffer 270 for preventing contamination of foreign objects between the rear peripheral wall 2654 and the secondary battery 264.

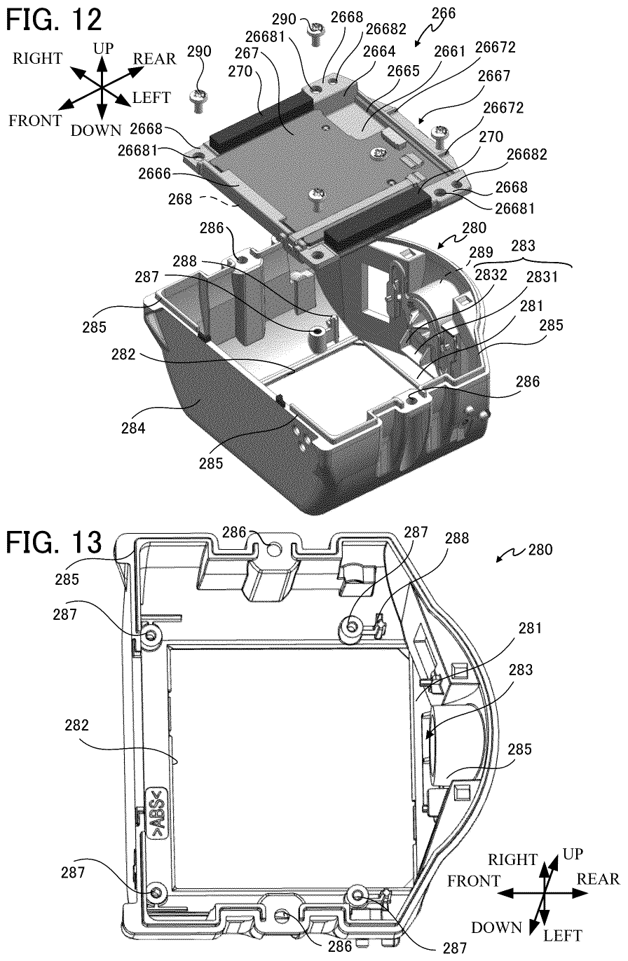

As illustrated in FIGS. 11, 12, and 13, the second casing 280 accommodates the coil retainer 266 to retain the power reception coil 268, a power reception substrate 267 that feeds the robot 200 with the electric power received by the power reception coil 268, the power reception coil 268 to be wirelessly connected to a power transmission coil 310 of a charging device 300, which is described below, and a coil tape 269 that protects the power reception coil 268. The second casing 280 forms the lower half of the outer shell of the torso 206, and engages with the first casing 250 in an orientation that a portion of the second casing 280 to be engaged with the first casing 250 faces in the upward direction or a first direction. The second casing 280 has a bottom 281 having a rectangular opening 282 and provided at a position of the second casing farthest from a portion engaged with the first casing 250. As illustrated in FIG. 4, the peripheral edges of the opening 282 surround the power reception coil 268 along the outer periphery of the second casing 280. As illustrated in FIGS. 4, 11, and 12, the second casing 280 has a coil retainer restrictor 283 therein at a lower back position. The coil retainer restrictor 283 comes into contact with a protrusion 2667 of the coil retainer 266 when the coil retainer 266 experiences a strong upward force. The coil retainer restrictor 283 has a parallel segment 2831 parallel to the main surfaces of the coil retainer 266, and vertical segments 2832 vertical to the main surfaces and serving as reinforcing ribs for the parallel segment 2831. The coil retainer 266 is fixed to the peripheral edges of the opening 282 by fastening fasteners 290 such as screws to four screw holes 287 and four screw holes 26681 of the coil retainer 266. The second casing 280 has a torso front 284 positioned adjacent to the coupler 205 with a slight gap therebetween. The second casing 280 has a left screw hole 286 and a right screw hole 286 at the upper end. Inserting and fastening fasteners 290 such as screws from the screw holes 286 to the screw holes 253 of the first casing 250 causes the first casing 250 and the second casing 280 to be fixed to and integrated with each other.

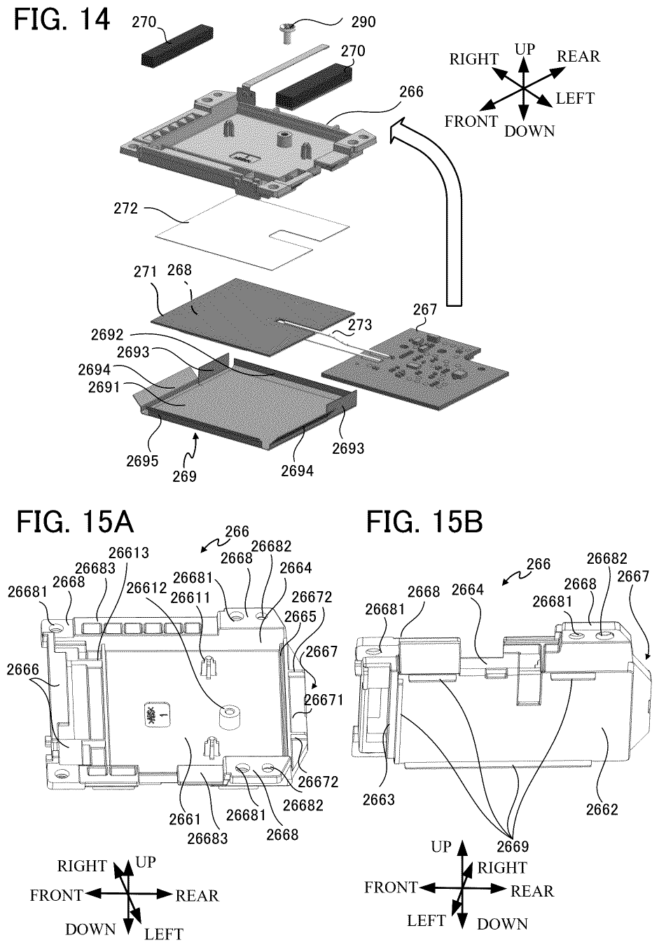

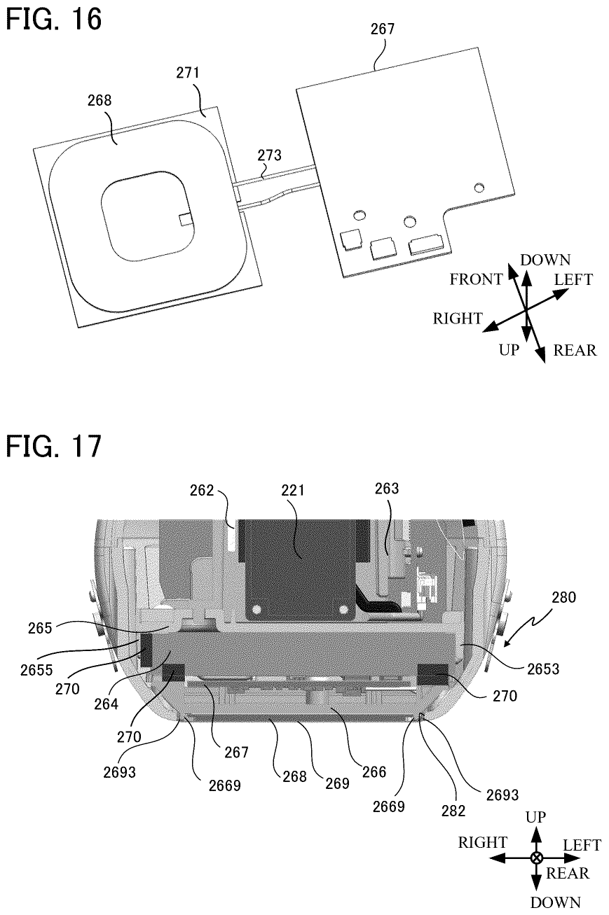

As illustrated in FIGS. 4, 11, 12, 14, 15A, and 15B, the coil retainer 266 has an upper main surface 2661 provided with the power reception substrate 267 with a gap therebetween, and has a lower main surface 2662 provided via a double-sided tape 272 with the power reception coil 268 (FIG. 16) stacked on a ferrite 271 (on the lower surface). The coil retainer 266 has upright segments 2663, 2664, 2664, and 2665 extending vertically from the upper main surface 2661. The coil retainer 266 retains the power reception substrate 267 by allowing the power reception substrate 267 to be mounted on placement projections 26611 and a flanged screw hole 26612 such that the circuit components of the power reception substrate 267 face the upper main surface 2661, allowing the front end of the power reception substrate 267 to be engaged with folded edge 2666, and allowing a single fastener 290 such as a screw to be fastened. The coil retainer 266 thus retains the power reception substrate 267 while accommodating the power reception substrate 267 therein. The coil retainer 266 has the protrusion 2667 that can come into contact with the coil retainer restrictor 283 of the second casing 280. The protrusion 2667 has a flat segment 26671 that comes into contact with the parallel segment 2831 to prevent deformation of the coil retainer 266 when the power reception coil 268 or the coil retainer 266 is pressed upward or experiences a load, and wall segments 26672 serving as reinforcing ribs that strengthens the flat segment 26671. Under normal conditions, the flat segment 26671 is opposed to the parallel segment 2831, with a space therebetween and no direct contact. The coil retainer 266 also has tabs 2669 fitted in the opening 282 of the second casing 280. The coil retainer 266 further has placement surfaces 26683 provided with the impact buffers 270. The coil retainer 266 is thus located below the secondary battery 264 so as to face the secondary battery 264 via the impact buffers 270 at the left and right ends, and supports the secondary battery 264 via the impact buffers 270. The coil retainer 266 has a rectangular flat-plate shape, with all four sides surrounded by the upright segments strengthen by reinforcing ribs 26613, and thus ensures high strength despite of an internal hollow space for retaining the power reception substrate 267. As illustrated in FIGS. 4, 5, and 14, the coil tape 269 is disposed over the power reception coil 268, and closes the opening 282. The coil tape 269 has bent ends 2692, 2693, 2694, and 2695, and is tightly held between the peripheral edges of the opening 282 and the coil retainer 266.

The robot 200 further includes components, such as various sensors, controllers, and storages, which have been widely known as disclosed in Unexamined Japanese Patent Application Publication No. 2024-104908, for example, although a detailed description of these components is not provided herein.

The following describes features, such as positional relationships among the components disposed inside the torso 206. As illustrated in FIG. 4, the first casing 250 of the torso 206 is provided with, in the order from the top to the bottom, the substrate base 263, the action unit fixture 262, the twist motor 221, the battery retainer 265, and the secondary battery 264. These components are at least partially overlap with each other in a direction along a first direction that is also referred to as the upward direction or the up-down direction. The second casing 280 is provided with, in the order from the top to the bottom, the power reception substrate 267, the coil retainer 266, the power reception coil 268, and the coil tape 269. These components are at least partially overlap with each other in the direction along the first direction. In more detail, the secondary battery 264 is disposed at the position closest to the opening 282 among the components accommodated in the first casing 250, whereas the impact buffers 270 mounted on the coil retainer 266 are disposed at the positions farthest from the opening 282 among the components accommodated in the second casing 280. The secondary battery 264 is supported by the impact buffers 270 mounted on the coil retainer 266. The secondary battery 264 is thus located at such a position in the first casing 250 as to be replaced immediately after separation of the first casing 250 and the second casing 280. This structure allows a user to extract the secondary battery 264 immediately after turning upside down the torso 206 and detaching the second casing 280. The secondary battery 264 is protected by the battery retainer 265 from the top and left sides, by the second casing 280 from the front side, and by the impact buffers 270 from the other sides (FIG. 17 etc.). This protection of the secondary battery 264 improves the safety of the robot 200. The coil retainer 266 has two insertion holes 26682 to which insertable projections 288 of the second casing 280 are introduced to prevent the coil retainer 266 from being displaced in the front-rear and right-left directions, and has the four screw holes 26681 and uses the four screw holes 26681 and screw holds 287 to be fixed to the peripheral edges of the opening 282 with the fasteners 290 to prevent the coil retainer 266 from being displaced in the up-down, front-rear, and right-left directions. This structure enhances the integration between the second casing 280 and the coil retainer 266 while also strengthening the second casing 280. In addition, the twist motor 221 and the action unit fixture 262 are disposed in a position overlapping vertically with the power reception coil 268, but on the opposite side relative to the power reception coil 268, that is, on the dorsal part of the robot 200. Therefore, the power reception coil 268 and the twist motor 221 can be compactly arranged when the robot 200 receives electric power from the abdominal part of the robot 200. Furthermore, the action unit fixture 262 and the twist motor 221 are disposed in a position overlapping vertically with the power reception coil 268 and the secondary battery 264, but on the opposite side relative to them, that is, on the dorsal part of the robot 200, and a gap is provided between the twist motor 221 and the battery retainer 265 or between the twist motor 221 and the secondary battery 264. This configuration enables the components such as the power reception coil 268, the secondary battery 264, and the twist motor 221 to be compactly arranged within the torso 206, while also preventing interference among components even in the presence of clearance during the fixation of the twist motor 221 or dimensional tolerances in the twist motor 221. Moreover, the secondary battery 264 and the action unit 208 that are arranged to overlap each other in the direction along the first direction is removable independently of each other.

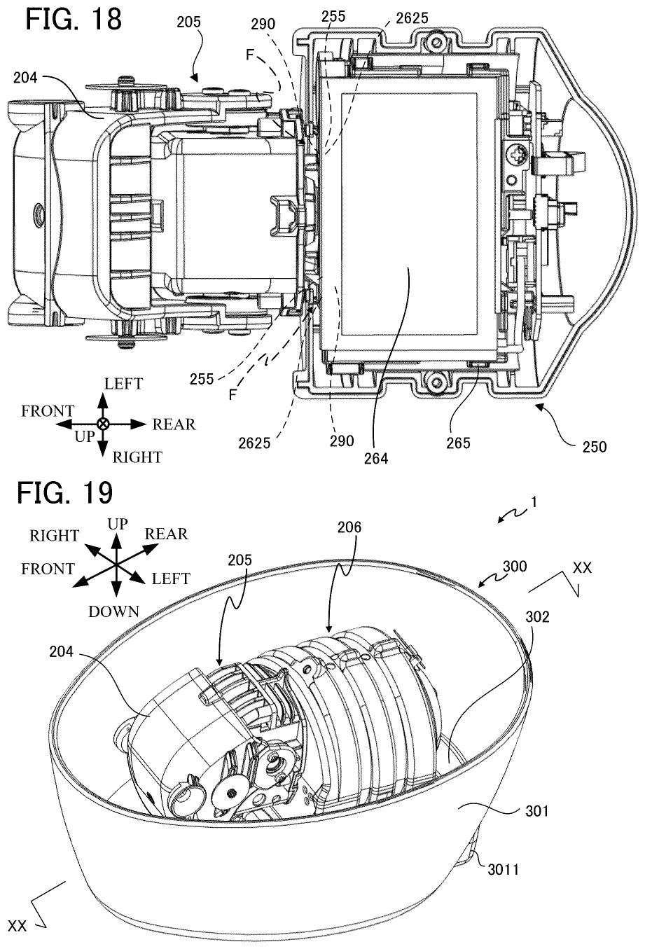

The robot 200 according to the present embodiment has the above-described configuration. The following describes a method of replacing the secondary battery 264 and the action unit 208 of the robot 200. First, replacement of the secondary battery 264 is described. First, the user unzips an unillustrated fastener on the exterior 201 of the robot 200, and extracts the housing 207. Next, the housing 207 is turned upside down, and the second casing 280 is detached from the housing 207. As illustrated in FIG. 18, the housing 207 after removal of the second casing 280 accommodates the secondary battery 264 such that the secondary battery 264 can be readily extracted from the first casing 250 or among the components disposed in the first casing 250, the secondary battery 264 protrudes the farthest toward the second casing 280 and is arranged with the main surface thereof on the side closest to the opening 282 exposed. Thereafter, the user replaces the exhausted (or broken, damaged) secondary battery 264 with a new secondary battery 264. The user then reattaches the second casing 280, restores the housing 207 in the exterior 201, and zips the fastener, thereby readily completing the battery replacement.

Subsequently, a method of replacing the action unit 208 is described. After removing the secondary battery 264 as described above from the state illustrated in FIG. 18, the battery retainer 265 is removed. As illustrated in FIG. 9, the removal of the battery retainer 265 that obstructs attachment and detachment of the fasteners 290 secured in the screw holes 2625 or that covers the motor fixture attachment sites F within the first casing 250 allows the user to access the screw holes 2625 of the action unit fixture 262 illustrated in FIG. 8B using a tool such as a screwdriver. The fasteners 290 secured in the screw holes 2625 are removed, and the action unit fixture 262 accommodating the twist motor 221 is pulled forward (FIG. 5). The extracted action unit 208 is then replaced with a new action unit 208. The action unit fixture 262 of the new action unit 208 is attached to the first casing 250, and the battery retainer 265 is mounted to the peripheral edges of the rear wall 2632, the left wall 2633, and the right wall 2634 of the substrate base 263, on the side closer to the second casing 280. Subsequently, the user replaces the secondary battery 264 on the battery retainer 265, reattaches the second casing 280, restores the housing 207 in the exterior 201, and zips the fastener, thereby readily completing the replacement of the action unit 208.

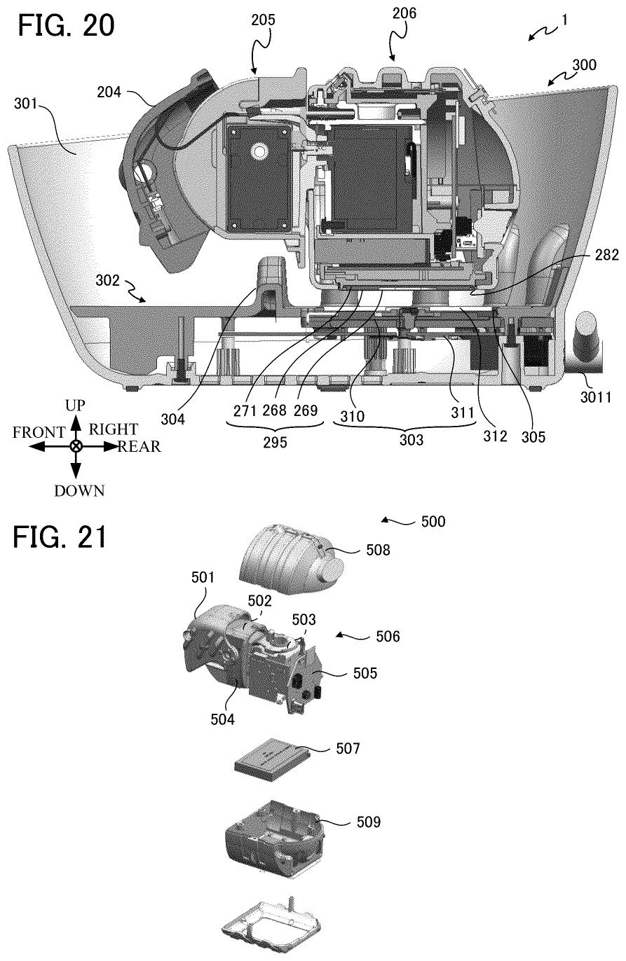

The following describes a configuration of the charging device 300 according to the embodiment. FIGS. 19 and 20 intended to describe the charging device 300 do not illustrate the exterior 201, in order to ensure the visibility of the figures. As illustrated in FIGS. 19 and 20, the charging device 300 has a bowl shape, and includes an outer cage 301, an inner bottom 302, and a power transmitter 303. The outer cage 301 defines the outer circumference of the charging device 300, and is made of an insulating member, such as plastic, for example. The outer cage 301 has a connector 3011 coupled to an AC adaptor, which is not illustrated, to be connected to an electric outlet. The inner bottom 302 receives the torso 206 of the robot 200 placed thereon, and is designed to be parallel to the power reception coil 268 included in the torso 206 of the robot 200 placed on the inner bottom 302. The inner bottom 302 has an alignment wall 304 and a power transmission opening 305 for alignment of the position of the torso 206 of the robot 200. The power transmitter 303 converts DC current fed from the AC adaptor into AC current, and feeds electric power to the robot 200 via a power transmission substrate 311, from the power transmission coil 310 disposed along the inner bottom 302 within the power transmission opening 305 (that is, from a power transmission coil unit exposed through the power transmission opening 305). The charging device 300 is provided with a coil tape 312 that covers the power transmission opening 305. The power transmission coil 310 and the coil tape 312 are components of a power transmission coil unit that transmits electric power in contactless charging. The power transmission coil unit may lack a coil tape, and may consist only of the power transmission coil 310. The robot 200 and the charging device 300 are components of a contactless charging unit.

As described above, the robot 200 according to the present embodiment includes a torso 206 that accommodates the secondary battery 264 that is a first consumable part, and at least a part of the action unit 208 that is a second consumable part, and the torso 206 includes a first casing 250 to which the secondary battery 264 and the action unit 208 are attached, and a second casing 280 that engages with the first casing 250. The secondary battery 264 is arranged to protrude the farthest toward the lower end, that is, toward the second casing 280 among the components disposed in the first casing 250, and is arranged to expose, from the first casing 250, the head 204 that is a movable section to be moved relative to the torso 206. In a case where the second casing 280 is detached from the torso 206, the action unit attachment site F is provided at a tool manipulatable position at which a tool is manipulatable for removing the action unit 208 from the first casing 250, the action unit attachment site F being a position where the action unit 208 is fastened to the first casing 250. Thus, maintenance of the secondary battery 264 and the action unit 208 can be performed easily. As described above, the robot 200 according to the present embodiment includes a head 204; a torso 206 that accommodates at least a part of an action unit fixture 262 that secures the twist motor 221 for operating the head 204 and the action unit 208; and a coupler 205 that rotatably couples the head 204 to the torso 206. The torso 206 includes a first casing 250 to which an action unit fixture 262 is attached, and a second casing 280 that engages with the first casing 250. The action unit 208 that includes the head 204, the coupler 205, the action unit fixture 262, and the twist motor 221 is configured such that these components are connected to each other either fixedly or rotatably. The action unit fixture 262 is fastened to the first casing 250, and with the second casing 280 being detached, the action unit attachment sites F where the action unit fixture 262 is fastened to the first casing 250 are provided at tool manipulatable positions in a space at which a tool for attaching and removing the action unit 208, including the twist motor 221, from the first casing 250. Accordingly, the robot 200 allows the user to remove the exterior 201, detach the second casing 280, remove the secondary battery 264 and the battery retainer 265, and then easily detach or attach the action unit 208 from/to the first casing 250, thereby facilitating replacement of the action unit 208 (motor). The first casing 250 has a motor fixture through-hole 251 that allows the action unit fixture 262 accommodating the twist motor 221, to move in the front-rear direction of the torso 206. Therefore, by detaching the second casing 280, removing the secondary battery 264 and the battery retainer 265, and detaching the fasteners 290 from the screw holes 2625, the user can slightly lift the action unit fixture 262 accommodating the twist motor 221 that is connected to the head 204 and the coupler 205 from the action unit fixture through-hole 251 to slide forward, thereby easily removing the action unit fixture 262 from the first casing 250, which enhances ease of maintenance. Furthermore, the circuit board for controlling the twist motor 221 and the vertical motor 222 is disposed at a position where the circuit board does not interfere with replacement of the action unit 208 of the torso 206, thus enabling smooth replacement of the action unit 208. In addition, the second casing 280 can be detached from the housing 207, such that the second casing 280 is accompanied by the components such as the power reception coil 268, the power reception substrate 267, and the coil retainer 266, located below the secondary battery 264, and the secondary battery 264 is disposed at the lowest position in the first casing 250. This structure allows the user to replace the secondary battery 264 immediately after turning upside down the housing 207 and detaching the second casing 280, which enhances ease of maintenance. As described above, the robot 200 according to the present embodiment allows for easy replacement of consumable parts such as the secondary battery 264, and the action unit 208 including the twist motor 221 and the vertical motor 222.

The above-described embodiment of the present disclosure is a mere example and not to be construed as limiting the application scope of the present disclosure. That is, the embodiments of the present disclosure may be provided with various modifications, and any modified embodiment can be encompassed in the scope of the present disclosure. For example, although the robot 200 is a pet robot in the above-described embodiment, the robot may also be an electronic device, such as cleaning robot or serving robot, driven by a secondary battery and excluding an exterior that resembles a small animal like the exterior 201, for example.

Although the torso 206 includes the first casing 250 and the second casing 280 in the above-described embodiment, the torso may also include a single casing having a detachable segment corresponding to the bottom 281, for example. Alternatively, the torso may include a single casing having an openable and closable door that enables readily replacement of a component, such as secondary battery or action unit, for example. A configuration including three or more casings is also acceptable. The first casing 250 and the second casing 280 may be structured in reverse relative to each other, or the second casing may be attached to the first casing in an openable and closable manner via a hinge or similar mechanism. The first consumable part and the second consumable part to be replaced may be components other than those described above, and the second consumable part may be a part of the action unit. Furthermore, although the first consumable part and the second consumable part are attached and detached using tools, they may instead be configured to allow manual attachment and detachment, for example, by employing a structure in which a recess and a projection are fitted together, or a structure similar to a snap button.

In the above-described embodiment, the secondary battery 264 and the battery retainer 265 are shaped and arranged so as to cover the action unit attachment site F; however, they may instead be shaped and arranged so as not to obstruct the action unit attachment site F.

Although the exterior 201 has the fur 203 in the above-described embodiment, the exterior may have feathers instead of the fur, or may resemble the skin of another organism, such as that of reptiles, for example.

Although the head 204 that resembles a small animal or a portion corresponding to the head 204 is movable in the above-described embodiment, the robot may include a movable tail or a portion corresponding to the tail instead of the movable head, or may include both the movable head and tail. Alternatively, the robot may include movable arms, legs, fingers, eyelids, mouth, or the like instead of the movable head, for example. Moreover, the configuration may also involve movement of non-animal-like mechanical arms or shafts.

In the above-described embodiment, the action unit fixture 262 is configured to fix the surface through which the motor rotational axis 2615 of the twist motor 221 protrudes and to cover the entire upper surface and the half of the left side surface. However, it may also be configured to cover the right side surface, or to cover the entire left side surface. While it is preferable to fix the surface through which the motor axis protrudes, a configuration that fixes the lower surface of the motor (motor section) or the like may also be employed. The number of motors included in a motor section may be one, or may be three or more. Although the motor section is configured such that one motor rotational axis 2615 protrudes outward, two or more motor axes may be provided and protruded, and the number of protruding axes may be equal to or different from the number of motors included in the motor section. The direction in which the head 204 operates may be limited to the up-down direction, to motion about the motor rotational axis 2615, to another direction, or a combination of these directions. Although the motor fixture through-hole is provided in the first casing 250, it may instead be provided in the second casing, or in both the first casing and the second casing.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

1. An electronic device comprising:
a body that accommodates a first consumable part and at least a part of second consumable parts, wherein
the body includes a first casing to which the first consumable part and the second consumable parts are attached, and a second casing that engages with the first casing in an orientation that the second casing faces the first casing in a first direction,
the first consumable part and the second consumable parts are arranged to at least partially overlap with each other in a direction along the first direction, and
the first consumable part and the second consumable parts that are arranged to overlap with each other in the direction along the first direction are configured to be removable independently of each other.

2. The electronic device according to claim 1, wherein
with the second casing being detached from the body, a first attachment site and a second attachment site are provided at tool manipulatable positions at which a tool is manipulatable for removing the first consumable part and the second consumable parts from the first casing, the first attachment site being a site at which the first consumable part is fastened to the first casing, the second attachment site being a site at which the second consumable parts are fastened to the first casing.

3. The electronic device according to claim 1, wherein
the first consumable part protrudes the farthest toward the second casing among components arranged in the first casing.

4. The electronic device according to claim 1, wherein
the second consumable parts include a motor section to operate a movable section to move relative to the body.

5. The electronic device according to claim 4, wherein
the first consumable part has a main surface that is arranged in the direction along the first direction to face the motor section.

6. The electronic device according to claim 5, wherein
the second consumable parts include a coupler to couple the movable section and the body.

7. The electronic device according to claim 6, wherein
the motor section includes a first motor to rotate the movable section in a circumferential direction of an motor rotational axis, the motor rotational axis extending from the body to the coupler.

8. The electronic device according to claim 7, wherein
the first motor is stabilized in a motor fixture for fastening the first motor to the first casing, and connects to the coupler via the motor rotational axis.

9. The electronic device according to claim 8, wherein
the motor section includes a second motor to rotate the movable section in a direction intersecting the motor rotational axis.

10. The electronic device according to claim 9, wherein
the second motor is accommodated in the coupler.

11. The electronic device according to claim 10, wherein
the first consumable part is a secondary battery, a power reception coil that performs contactless charging with the secondary battery has a main surface, and at a position of the second casing farthest from a portion engaged with the first casing, the power reception coil is arranged such that the main surface of the power reception coil is located in the direction along the first direction.

12. The electronic device according to claim 11, wherein
the first motor is disposed to face the main surface of the power reception coil.

13. The electronic device according to claim 11, wherein
the motor fixture supports a surface of the first motor farthest from the power reception coil.

14. The electronic device according to claim 13, wherein
between the first motor and the power reception coil, the secondary battery and a battery retainer to retain the secondary battery are provided, the secondary battery feeding electric power to the first motor.

15. The electronic device according to claim 14, wherein
between the first motor and the secondary battery or between the first motor and the battery retainer, a gap is provided.

16. The electronic device according to claim 15, wherein
the body includes a coil retainer attached to opening provided to the second casing.

17. The electronic device according to claim 16, wherein
to the coil retainer, the power reception coil and a power reception substrate connected to the power reception coil are attached.

18. The electronic device according to claim 8, wherein
the motor fixture is attached to the first casing by an attachable and detachable fastener.

19. A contactless charging system comprising:
a pet robot including the electronic device according to claim 1, an exterior that resembles an organism, and a power reception coil that performs contactless charging, the electronic device being covered with the exterior; and
a charging device including an inner bottom and a power transmission coil to contactlessly transmit electric power to the electronic device placed on the inner bottom, wherein
the inner bottom has a power transmission opening, and
the power transmission coil is provided at a position inside the power transmission opening and along the inner bottom.

20. A contactless charging system comprising:
a pet robot including the electronic device according to claim 2, an exterior that resembles an organism, and a power reception coil that performs contactless charging, the electronic device being covered with the exterior; and
a charging device including an inner bottom and a power transmission coil to contactlessly transmit electric power to the electronic device placed on the inner bottom, wherein
the inner bottom has a power transmission opening, and
the power transmission coil is provided at a position inside the power transmission opening and along the inner bottom.
